(19) United States
(12) Patent Application Publication
(10) Pub. No.: US 2017/0083949 A1
(43) Pub. Date: Mar. 23, 2017

(54) POINT OF SALE TRANSACTION BASED TARGETED ADVERTISING TECHNICAL FIELD

(71) Applicant: MasterCard International Incorporated, Purchase, NY (US)

(72) Inventor: Ankur Arora, New Delhi (IN)

(21) Appl. No.: 15/249,888

(22) Filed: Aug. 29, 2016

(30) Foreign Application Priority Data
Sep. 18, 2015 (SG) 10201507784R

(51) Int. Cl. G06Q 30/02; G06Q 20/20

(52) U.S. Cl. CPC G06Q 30/0268; G06Q 20/20; G06Q 30/0238

(57) ABSTRACT

A method and system for point of sale (POS) transaction based individualized targeted marketing is provided. The method includes, for a point of sale (POS) transaction involving a POS merchant and a POS customer, pushing an advertisement to the POS customer for another merchant in response to the other merchant's distance from the POS merchant and additional parameters. The additional parameters may include historical transaction data for the POS customer, the probability of follow on purchase in a merchant type of services by the POS customer, and merchant ratings.

### CROSS-REFERENCE TO RELATED APPLICATION

This application is a U.S. National Stage filing under 35 U.S.C. §119, based on and claiming benefit of and priority to SG Patent Application No. 10201507784R filed Sep. 18, 2015.

### TECHNICAL FIELD

The present invention generally relates to methods and apparatus for marketing, and more particularly relates to methods and apparatus for point of sale (POS) transaction based weighted targeted merchant advertising.

### BACKGROUND OF THE DISCLOSURE

Advertising can take many forms: billboards, television commercials and printed flyers. In today's wireless world, we receive advertisements at our wireless devices from goods and services providers. Targeted advertising has developed where advertisers pay a premium for marketing information to be able to provide advertising to individuals who have used their good in the past or have been determined to be likely to buy their goods or services. For example, grocery loyalty programs develop a database of what people purchase and provide this information to targeted marketers so that they can target individuals for sale of certain goods.

With the development of electronic point-of-sale (POS) settlement by a person's wireless device (e.g., cellular telephone), another opportunity for advertising is presented. However, normally such advertisements are generalized and not very targeted. Even if targeted based upon a purchase in a present transaction, the advertisement is tailored to an individual. Even if a merchant is able to tailor an advertisement based on previous transactions, such as targeted marketing, there is currently no marketing solution which provides near real time location-based marketing to targeted individuals.

Thus, what is needed is a method and system for targeted individualized advertising during electronic POS payment transaction settlement. Furthermore, other desirable features and characteristics will become apparent from the subsequent detailed description and the appended claims, taken in conjunction with the accompanying drawings and this background of the disclosure.

### SUMMARY

According to at least one embodiment of the present invention a method for point of sale (POS) transaction based individualized targeted marketing is provided. The method includes, for a point of sale (POS) transaction involving a POS merchant and a POS customer, pushing an advertisement to the POS customer for another merchant in response to the other merchant's distance from the POS merchant and additional parameters.

In accordance with another aspect of at least one embodiment of the present invention, a system for individualized POS targeted marketing is provided. The system includes a processor and a database. The processor is coupleable to a POS transaction settlement device at a first merchant and couples to the POS transaction settlement device for settling a transaction between the first merchant and a customer. The processor also determines an advertisement individualized for the customer settling the transaction at the first merchant and pushes the advertisement details to the customer. The database includes merchant data and customer data, wherein the merchant data includes merchant location information and merchant type of services information for the first merchant and a plurality of second merchants and the customer data includes historical transaction data for the customer. The processor determines the advertisement individualized for the customer in response to the merchant data and/or the customer data.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present invention, by way of non-limiting example only, wherein:

FIG. 1 illustrates a block diagram of a system for individualized point of sale (POS) targeted marketing in accordance with a present embodiment;

FIG. 2 illustrates an example of operation of the system of FIG. 1 in accordance with the present embodiment;

FIG. 3 illustrates a flow chart of the operation of the system of FIG. 1 in accordance with the present embodiment;

And FIG. 4 illustrates a block diagram of a system for individualized point of sale (POS) targeted marketing in accordance with an alternate embodiment.

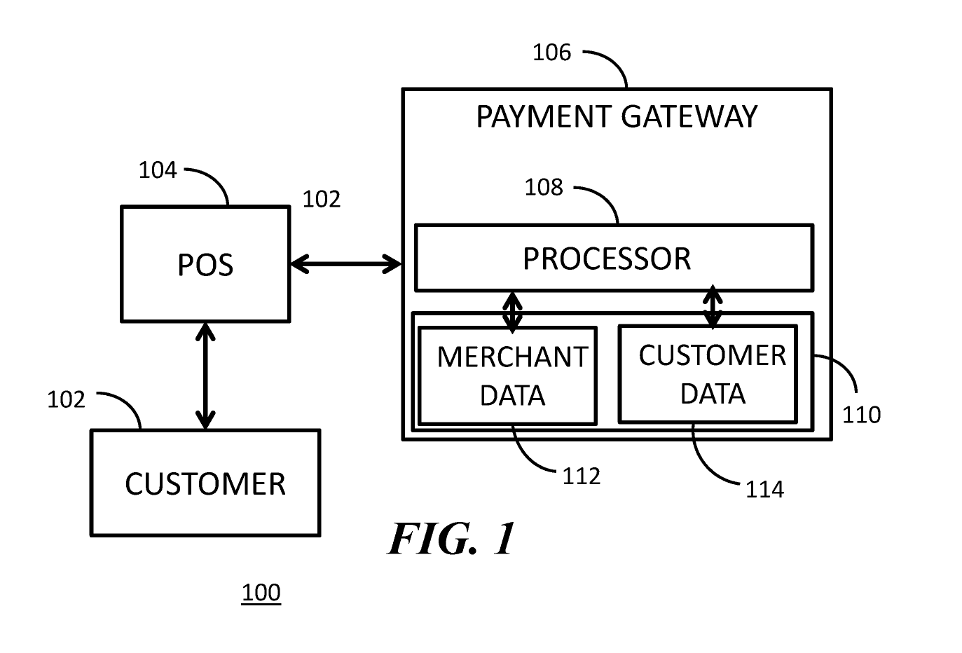

Skilled artisans will appreciate that elements in the figures are illustrated for simplicity and clarity and have not necessarily been depicted to scale. For example, the location of elements in the block diagram of FIG. 1 may not be to scale and other conventional transaction settlement participants are not shown in the FIG. 1.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a solution which uses a transaction made at a merchant to identify the location of the customer and pushes contextually relevant advertisements to that customer so as to incentivize him/her to visit a nearby merchant (e.g., a merchant the customer has visited before or where the customer has a high probability of purchase).

Referring to FIG. 1, a block diagram illustrates a system 100 for individualized point of sale (POS) targeted marketing. When a customer 102 utilizes a debit/credit card to settle a transaction at a merchant's POS transaction settlement device 104, a payment gateway 106 coupled to the POS transaction settlement device 104 for settling the transaction discovers the location of the customer 102. A processor 108 of the payment gateway 106 utilizes a database 110 including merchant data 112 and customer data 114 to compose an advertisement individualized for the customer. The processor 106 then pushes the advertisement to the customer 102.

The advertisement is generated in response to either or both of the merchant data 112 and the customer data 114. The merchant data 112 includes location information and merchant type of services information for the merchant settling the transaction with the customer 102 and other merchants. The customer data 114 includes historical transaction data for the customer 102.

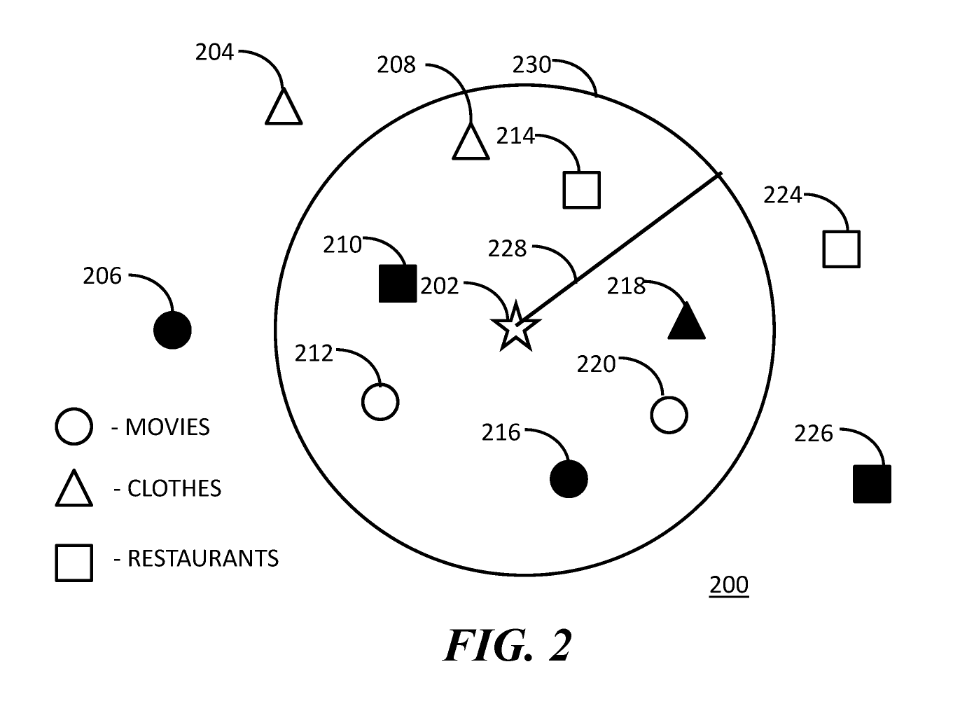

Referring to FIG. 2, a diagram 200 depicts an exemplary operation of the system 100 in accordance with the present embodiment. The merchant 202 is a clothing store and is the merchant settling the transaction with the customer 102. Other merchants include clothing stores 204, 208, 218, movie theatres 206, 212, 216, 220, and restaurants 210, 214, 224, 226. Only merchants who have registered with the system 100 can have advertisements for their goods or services pushed to the customer 102. Solid icons in the diagram 200 indicate that the merchants 206, 210, 216, 218, 226 are registered with the system 100. Also, the merchants considered for targeted advertising are limited by their distance 228 from the merchant 202 (i.e., within the circle 230).

An algorithm calculates an advertisement score for merchant ads to be pushed to the customer 102. For example, the advertisement score may be calculated as a weighted sum of (a) an inverse of the distance of each merchant from the location of the customer 102, (b) repeat purchases by the customer at that merchant, (c) a probability of purchase in the type of goods or services (e.g., shopping, restaurant and movie) provided by the merchant based on a past purchase sequence pattern of the customer 102 calculated from his past historical purchase data, and (d) a rating factor of the merchant. Thus, in accordance with this example, the advertisement score for each merchant is calculated as:

Advertisement Score=2/distance+w2*Repeat Purchases+w3*Probability of purchasing in type of goods/services based on past purchase sequence pattern derived from historical data+w4*Merchant rating [Equation 1]

where w1, w2, w3, and w4 are the weights given to each of the weighted factors. Those skilled in the art will realize that other variables may be added to calculation of the advertisement score or other variations of the present calculation of the weighted variables may be used. For example, the distance variable may be weighted differently for different types of goods or services (e.g., a customer 102 may be willing to go a longer distance for fine dining while only willing to go a short distance for a quick coffee).

In addition to the distance variable being adjusted in accordance with the goods or services provided by the advertising merchants, the distance 228 is also dynamic and adjusted according to the contextual knowledge of the type of the merchant 202 having the POS 104 where customer 102 presented his debit/credit card. For example if the merchant 202 is located in a shopping mall, the distance is defined as a boundary of the mall and includes all the merchants inside the mall. If, as is shown in the diagram 200, the merchant 202 is on a highway, the distance 228 is calculated in terms of places which are at a predetermined radius 228 (e.g., a five kilometer radius or within a comfortable driving distance) from the merchant 202 where the transaction took place. Those skilled in the art will realize that the distance may also be assessed in ways other than the linear distance between two locations, for example by the driving distance of the route on the roads, or by the time that is required to travel between the two locations.

The merchant rating is a rating factor that is a qualitative factor. For example, the rating factor could range from 0%-100%. The merchant rating is calculated based on current discounts or cashback offers being made available by the merchant. This factor is included to allow merchants to improve their ranking by giving an additional discount offer, thereby resulting in a higher advertisement score.

Referring back to the diagram 200, the merchants having solid icons (i.e., merchants 206, 210, 216, 218, 226) have registered with the system 100. The customer 102 just completed a transaction at the merchant 202 and radius 228 determines merchants to be considered for advertisements to be pushed to the customer 102 (i.e., the merchants 208, 210, 212, 214, 216, 218, 220 within the area of the circle 230). Based on the previous transaction history of the customer 102 and the location of the merchant 202, the algorithm determines the merchants whose ads are to be pushed to the customer 102: merchants 210, 216, 218. Even though the customer 102 had visited restaurants 206, 212 previously, because restaurant 206 is beyond the radius 228 and restaurant 212 has not enrolled, their ads are not pushed through to the customer 102.

Of the merchants 210, 216, 218, the customer 102 is shown an advertisement for the merchant 210 on top because historical transactions of the customer 102 show that the customer 102 likes to go to restaurants after shopping for clothes.

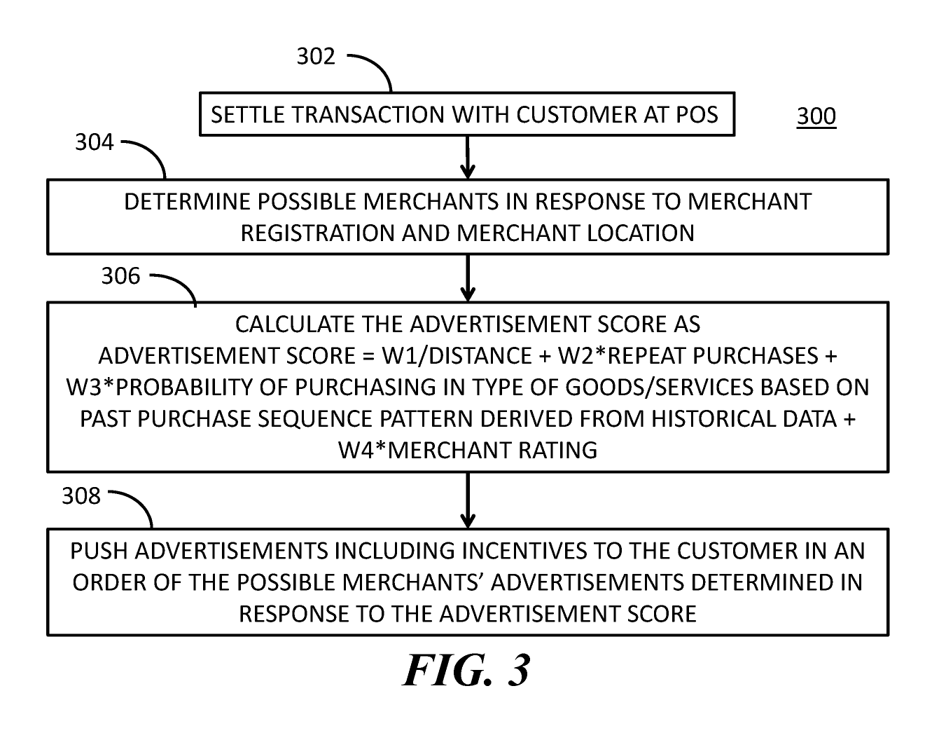

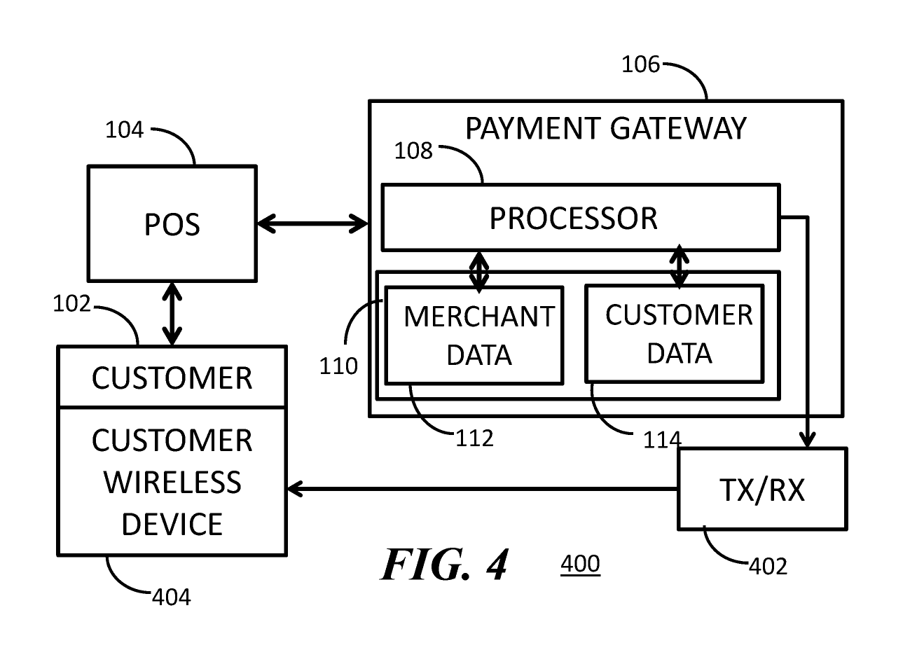

Referring to FIG. 3, a flowchart 300 is illustrated depicting operation of the processor 108 in accordance with the present embodiment. When the transaction with the customer 102 is settled 302 at the POS 104, possible merchants for pushing advertisements to the customer 102 are determined 304 in response to locations of the merchants and registration of the merchants. Then, the advertisement score is calculated 306 for each of the possible merchants. Finally, advertisements, including incentives, are pushed 308 to the customer 102 in an order of possible merchants determined in response to the calculated advertisement scores.

Thus, it can be seen from the flowchart 300 that the advertisements are pushed 308 from the processor 108 to the customer 102 after settlement of the transaction 302. As the customer 102 is at the POS 104 which is coupled to the processor 108 for settlement of the transaction 302, the advertisements could be pushed to the customer 102 via the POS 104 (e.g., via Near Field Communication (NFC) between the customer 102 and the POS 104 or by advertisements printed by the POS 104 and given to the customer 102 with receipts for the transaction).

Referring to FIG. 4, a system 400 in accordance with an alternate embodiment is depicted. In this alternate embodiment, the system 400 includes a transceiver 402 coupled to the processor 108. In addition, the customer 102 has a wireless device 404 in his possession. In the system 400, the processor 108 has the alternative of pushing 308 the advertisements to the customer 102 by providing the advertisements to the transceiver 402 which transmits the advertisements to the customer wireless device 404. In this case, the customer 102 can utilize his wireless device to load an application which can provide selected credit/debit card data to be made available to the payment gateway 106 to make historic transactions corresponding to the selected credit/debit card data in the customer data 114 available for utilization in accordance with the present embodiment. If the customer 102 has not logged into the application, (i.e., the credit/debit card details are not available), the repeat purchases and purchase history of the customer may not be available. In this scenario, only the distance and the rating factor of the merchant are taken into account for calculating the advertisement score for the merchant. The two other variables, repeat purchases at merchants and probability of purchase at next category are optionally used for credit/debit card details provided to the payment gateway in other ways (e.g., swiping the credit/debit card at the POS 104 to settle the transaction). So, it is apparent to those skilled in the art that any two factors available at any time can be used to construct the advertisement score of the merchants.

Thus, it can be seen that the present embodiment can provide a method and system for targeted individualized advertising during electronic POS payment transaction settlement. In this manner, it advantageously provides discount and cashback incentives tailored to the location and historic spending record of the customer 102. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

What is claimed is:

1. A method for point of sale (POS) transaction based individualized targeted marketing comprising:
for a point of sale (POS) transaction involving a POS merchant and a POS customer, pushing an advertisement to the POS customer for another merchant in response to the other merchant's distance from the POS merchant and additional parameters.

2. The method in accordance with claim 1 wherein the step of pushing the advertisement to the POS customer comprises pushing the advertisement to the POS customer for the other merchant in response to the additional parameters which include additional merchant parameters, where the additional merchant parameters comprise type of services provided by the other merchant and ratings of the other merchant.

3. The method in accordance with claim 1 wherein the advertisement pushed to the POS customer comprises a merchant incentive provided to the customer to visit the other merchant, and wherein the step of pushing the advertisement to the POS customer comprises determining the merchant incentive to provide to the POS customer in response to the type of services provided by the other merchant and a merchant rating of the other merchant.

4. The method in accordance with claim 3 wherein the merchant rating of the other merchant is determined in response to the discounts offered and/or the cashbacks provided.

5. The method in accordance with claim 3 wherein the merchant incentive provided to the customer to visit the other merchant comprises a discount for goods and/or services provided by the other merchant.

6. The method in accordance with claim 1 wherein the step of pushing the advertisement to the POS customer comprises pushing the advertisement to the POS customer for the other merchant in response to the additional parameters which include additional customer parameters, where the additional customer parameters comprise historical transactions of the POS customer including historical transactions of the customer with the other merchant.

7. The method in accordance with claim 6 wherein the advertisement pushed to the POS customer comprises an incentive provided to the customer to visit the other merchant, and wherein the step of pushing the advertisement to the POS customer comprises determining the incentive to provide to the POS customer in response to a probability of a follow on purchase at the other merchant determined in response to the goods and/or services provided by the first merchant and by the other merchant and historical transaction data for the POS customer.

8. A system for individualized point of sale (POS) targeted marketing, the system comprising:
a processor coupleable to a POS transaction settlement device at a first merchant, wherein the processor couples to the POS transaction settlement device for settling a transaction between the first merchant and a customer, and wherein the processor also determines an advertisement individualized for the customer settling the transaction at the first merchant and pushes the advertisement details to the customer; and
a database comprising merchant data and customer data, wherein the merchant data comprises merchant location information and merchant type of services information for the first merchant and a plurality of second merchants and the customer data includes historical transaction data for the customer, wherein the processor determines the advertisement individualized for the customer in response to the merchant data and/or the customer data.

9. The system in accordance with claim 8 wherein the processor pushes the advertisement details to the POS transaction settlement device during settlement of the transaction for onward provision to the customer.

10. The system in accordance with claim 8 further comprising a transceiver device coupled to the processor, and wherein the processor retrieves customer mobile contact information associated with the customer settling the transaction at the first merchant from the customer data and provides the advertisement details to the transceiver device for onward transmission to a mobile device of the customer in accordance with the customer mobile contact information.

11. The system in accordance with claim 8 wherein the merchant data further includes merchant ratings for the plurality of second merchants, and wherein the advertisement includes a merchant incentive for one of the plurality of second merchants, the merchant incentive determined in response to the merchant type of services and the merchant ratings for the one of the plurality of second merchants.

12. The system in accordance with claim 11 wherein the merchant ratings of the plurality of second merchants comprise ratings determined in response to the discounts offered and/or the cashbacks provided.

13. The system in accordance with claim 11 wherein the merchant incentive provided in the advertisement pushed to the customer comprises a discount for goods and/or services provided by the one of the plurality of second merchants.

14. The system in accordance with claim 8 wherein the historical transaction data for the customer comprises prior transactions at each of the plurality of second merchants and/or past purchase history associated with merchant type of services information determined from the prior transactions at each of the plurality of second merchants.

15. The system in accordance with claim 14 wherein the advertisement is individualized for the customer in response to a probability of follow on purchase in merchant types of services determined in response to the past purchase history associated with merchant type of services information determined from the prior transactions at each of the plurality of second merchants.

16. The system in accordance with claim 15 wherein the merchant data further includes merchant ratings for the plurality of second merchants, and wherein the advertisement includes a merchant incentive for one of the plurality of second merchants, the merchant incentive determined in response to the merchant type of services and the merchant ratings for the one of the plurality of second merchants.

17. The system in accordance with claim 16 wherein the advertisement is individualized for the customer in response to a weighted relationship of the merchant location information for the one of the plurality of second merchants associated with the advertisement, the historical transaction data for the customer with the one of the plurality of second merchants, the probability of follow on purchase in one of the merchant types of services provided by the one of the plurality of second merchants, and the merchant ratings of the one of the plurality of second merchants.
